(19) United States
(12) Patent Application Publication
(10) Pub. No.: US 2025/0135411 A1
(43) Pub. Date: May 1, 2025

(54) METHOD AND APPARATUS FOR GENERATING BUBBLES WITHIN A LIQUID IN REAL TIME

(71) Applicant: Design PDV LLC, Charlotte, NC (US)

(72) Inventor: Roderick M. Dayton, Charlotte, NC (US)

(21) Appl. No.: 18/930,948

(22) Filed: Oct. 29, 2024

Related U.S. Application Data
(60) Provisional application No. 63/546,224, filed on Oct. 29, 2023.

(51) Int. Cl. B01F 23/2375; B01F 23/233; B01F 35/21; B01F 35/22; B01F 35/71

(52) U.S. Cl. CPC B01F 23/2375; B01F 23/2332; B01F 35/211; B01F 35/2209; B01F 35/7173

(57) ABSTRACT

Provided are a method and apparatus for generating ultrafine bubbles in a liquid. The method involves introducing, in real time, and at a time when dispensation of the liquid with ultrafine bubbles is to occur, the liquid into a liquid chamber. A bubble generator is activated to impart a shearing force on the liquid within the liquid chamber to cause cavitation of the liquid that results in formation of the ultrafine bubbles. The liquid containing the ultrafine bubbles that exits the liquid chamber is dispensed, to be imparted onto a target object.

### CROSS-REFERENCE TO RELATED APPLICATIONS

This application claims the benefit of U.S. Provisional Application No. 63/546,224, filed Oct. 29, 2023, which is incorporated in its entirety herein by reference.

### BACKGROUND OF THE INVENTION

### 1. Field of the Invention

This application relates generally to a method and apparatus for generating bubbles in a liquid on demand and, more specifically, to a method and apparatus that imparts a shear force on a liquid to generate ultrafine bubbles at a time when dispensing of the liquid is desired.

### 2. Description of Related Art

Conventional techniques to generate bubbles in a liquid include using a bubble generator diffusing compressed oxygen into fast-flowing water, which further spreads and dissolves bubbles. Such bubble generators can have an oxygen transfer efficiency of up to 85%. Other techniques can involve the pressurized dissolution, electrolysis or swirling of fluids in a mixing chamber and then feeding the fluids through an injector or a venturi to produce air bubbles, and the liquid with the bubbles is stored in a reservoir. Although such bubbles may exist in solution for several weeks and into months, they will likely float, and migrate to the surface of the stored liquid much sooner. Thus, the stored fluid drawn from adjacent to the bottom of the reservoir will typically have a low concentration of the bubbles, which causes the stored fluid drawn from such a location in the reservoir to exhibit limited beneficial properties associated with such bubbles.

### BRIEF SUMMARY OF THE INVENTION

Accordingly, there is a need in the art for a method and apparatus that generates ultrafine bubbles in a liquid on demand, approximately at a time when the liquid with the bubbles is to be dispensed. For example, the method and apparatus can involve imparting a shear force on a liquid to generate ultrafine bubbles at a time when filing a dispenser of the liquid is desired.

According to one aspect, the subject application involves a method and apparatus for generating ultrafine bubbles in a liquid. The method involves introducing, in real time, and at a time when dispensation of the liquid with ultrafine bubbles is to occur, the liquid into a liquid chamber. A bubble generator is activated to impart a shearing force on the liquid within the liquid chamber to cause cavitation of the liquid that results in formation of the ultrafine bubbles. The liquid containing the ultrafine bubbles that exits the liquid chamber is dispensed into a reservoir to later be imparted onto a target object.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 is a side view of a bubble generating system that includes an inlet, a bubble generator, and an outlet in accordance with some aspects of the present disclosure;

FIG. 2 is a partially cutaway view of a bubble generator with a housing portion of an upper liquid cavity removed, showing a motor operatively connected to a rotor assembly, to rotate the rotor assembly adjacent to a shear wall and thereby introduce cavitation into a liquid; and

FIG. 3 is an enlarged, perspective view of a rotor assembly seated adjacent to a shear wall within a lower liquid cavity.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

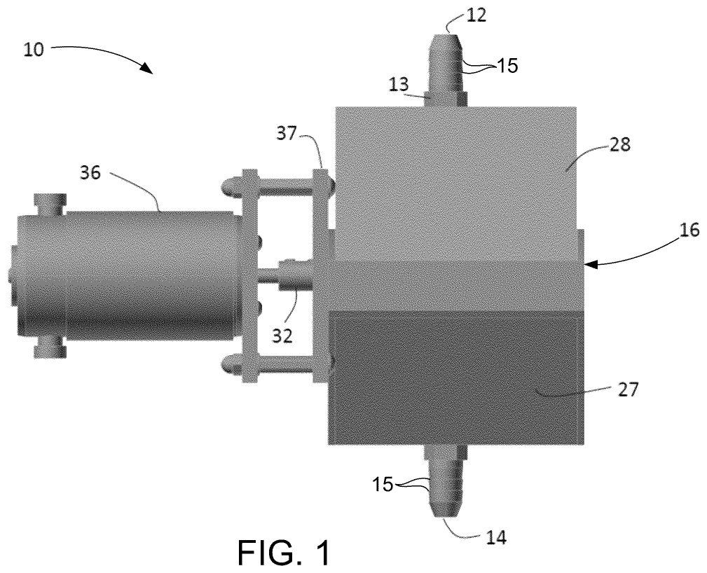

FIG. 1 shows a side view of an illustrative embodiment of a bubble generator assembly 10 that includes an inlet port 12 and an outlet port 14 coupled to a bubble generator 16. The inlet port 12 defines a conduit that directs a liquid into the bubble generator 16 and the outlet port 14 defines a conduit that directs the processed liquid into a reservoir or other receptacle for holding the liquid entrained with ultrafine bubbles, which can subsequently be applied to a surface. The liquid can be any liquid in which ultrafine bubbles are to be generated to be applied to a surface for a particular application. For example, for disinfection or decontamination applications, the liquid can be water, an aqueous solution including a combination of water and a decontamination agent such as hydrogen peroxide, peracetic acid, citric acid, and the like, or any other type of liquid decontamination agent.

According to some embodiments, the inlet port 12 and/or outlet port 14 can include a plurality of barbs 15. The barbs 15 can include a plurality of concentrical sections with ramped surfaces terminating at a sharp edge. A hose (not shown) can be pushed onto the inlet port 12 and/or outlet port 14, with a leading end of the hose sliding over the ramped surfaces before passing over the sharp edge. A portion of the hose can optionally deform after passing over the sharp edge to extend radially inward toward a central region of the respective inlet port 12 and/or outlet port 14, thereby interfering with removal of the hose.

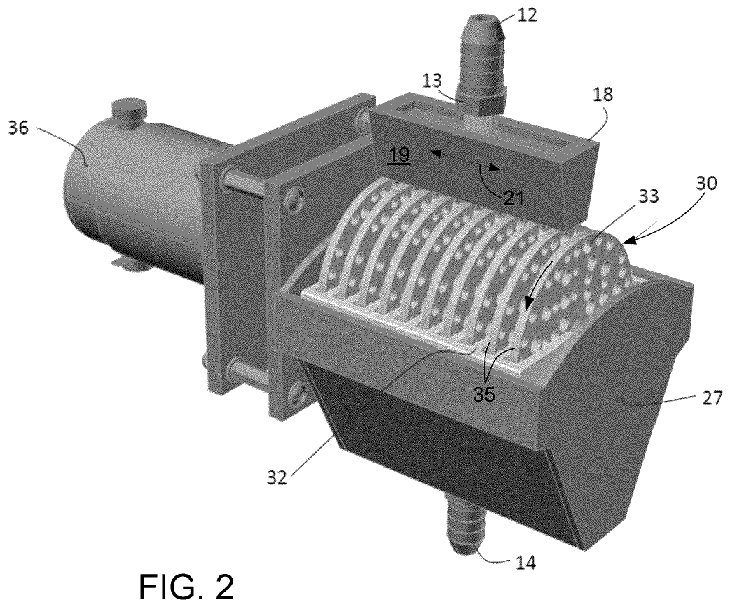

The bubble generator 16 includes a funnel 18 (FIG. 2) in fluid communication with the inlet port 12. The funnel 18 can optionally be disposed within an interior of an upper liquid cavity 28 that forms a portion of an enclosure housing one or a plurality of rotors 30. The funnel 18 includes a tapered wall 19 that at least partially defines an elongated passage through which the liquid passes to be dispersed in the elongated directions indicated generally by arrows 21, and directed generally toward one or the plurality of rotors 30. Accordingly, liquid entering the upper liquid cavity 28 through the inlet port 12 flows over the one or plurality of rotors 30, to be exposed to a shearing force imparted on the liquid through relative rotation of the rotor 30 and a shear wall 32 (FIG. 2).

The inlet port 12 receives liquid in which bubbles are to be generated. The liquid introduced into the inlet port 12 can be open to the atmosphere or gravity fed and without pressurization from a separate pump. Alternative embodiments of the inlet port 12 may be fed from a pressurized liquid source that introduces the liquid to the inlet port 12 at an elevated pressure above atmospheric pressure.

The inlet port 12 receives liquid in which bubbles are to be generated where the liquid can be a chemical solution, chemical suspension, etc. For example, the liquid can be an aqueous solution including a combination of water and a decontamination agent such as hydrogen peroxide, peracetic acid, citric acid, and the like, or any other type of liquid decontamination agent. Alternatively, the liquid introduced into the inlet port 12 may be water for use in the later dilution of a chemical solution such as a concentrated liquid decontamination agent, or for direct application to a surface or introduction to a receptacle.

Embodiments of the rotor 30 can include at least one, and optionally a plurality (e.g., two, three, four, five or more) discs 35 or objects of other shapes. The quantity of discs 35 can be sufficient to allow for the introduction of the liquid at atmospheric pressure through the inlet port 12, yet achieve the formation of ultrafine bubbles as described herein.

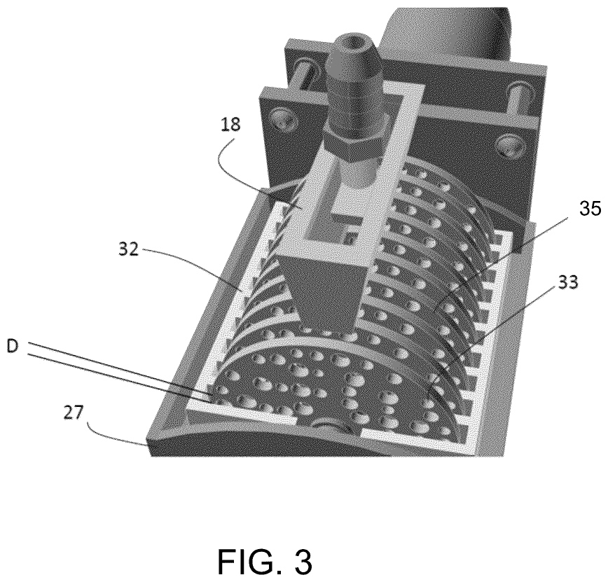

Each disc 35 can include one or a plurality of shearing nibs 33 (shown most clearly in FIGS. 2 and 3) that introduce cavitation to the liquid introduced via the inlet port 12 within the upper liquid chamber 28 and lower liquid chamber 27. According to the embodiment illustrated in FIG. 2, the rotor 30 includes ten discs 35, with each disc 35 being disposed within the upper liquid cavity 28 and lower liquid cavity 27 and separated from each other by a shear wall 32. The discs 35 have exterior dimensions that closely approximate the interior dimensions of the space defined by shear walls 32 on opposite sides of the discs 35. Although referred to herein as “discs” 35 for illustrative purposes, the physical configuration of the rotating structures referred to as discs 35 is not so limited. Alternate embodiments of the discs 35 can be a rotating or pivoting set of spokes, for example. Such spokes would also pass within close proximity of the shear walls 32 on opposite sides of the spokes, imparting a shearing force on the liquid between the shear walls 32 and the rotating or pivoting spokes. According to yet other embodiments, the discs 35 can be counter-rotating structures that rotate adjacent to each other in opposite angular directions in a scissors-like motion, shearing the liquid between such oppositely-rotating structures. For the sake of clarity and brevity, however, the discs 35 are shown in the drawings and described herein as being round, rotating disc-shaped structures.

To introduce cavitation, an electric motor 36 is operatively connected to the rotor assembly 30, to cause rotation of the one or more discs 35 in a direction generally indicated by arrow 37. The nib(s) 33 on each rotor 30 are thru holes that carry liquid from the upper liquid cavity 28 to the lower liquid cavity 27 and generate a shearing effect as the nibs 34 rotate and pass adjacent to the shear wall 32 that is separated a distance D (FIG. 3) from a major face of the discs 35 or other rotating structure. The distance D is small enough to apply a shearing force on the liquid in the liquid passing from the upper liquid cavity 28 to the lower liquid cavity 27, thereby causing cavitation in the liquid. For example, the distance D can be within a range from about half (0.5) mm to about three (3) mm, and the shear wall 32 can have a shape that closely approximates a contour of an exterior, facing surface of the disc 35. The distance D can optionally be varied to achieve the desired level of cavitation and/or ultrafine bubble formation as a function of at least one of: a viscosity of the liquid, a flow rate at which the liquid is introduced via the inlet port 12, and an angular velocity at which the rotor assembly 30 and/or discs 35 are rotated.

Although the nib(s) 33 are described herein as holes extending through a depth of the discs 35 in an orthogonal direction to the major face of the discs 35, the nib(s) 33 can extend partially (but optionally less than fully) through the discs 35, can include projections that protrude outward from a major face of the discs 35, or a combination thereof.

When the rotor assembly 30 and/or discs 35 are driven, the nibs 33 are driven through the liquid, a portion of which is sheared between the shearing wall 32 and the exterior surface of the discs 35 before being transported into the lower liquid cavity 27. According to some embodiments, a portion of the liquid within the nib(s) can be sheared by an upper portion of the nib(s) 33 passing adjacent to an edge of the shear wall 32. The electric motor 36, which can operate off of a nominal 12 volts DC power supply, for example, can drive the rotor assembly 30 at any desired angular velocity to cause a degree of cavitation that generates a suitable quantity of ultrafine bubbles in the liquid to achieve the desired effect. For example, the quantity of ultrafine bubbles can be suitable to generate a surfactant-like effect to adequately wet a surface to achieve a desired level of decontamination. As another example, the quantity of ultrafine bubbles can be suitable to cause penetration into a body on which the liquid with ultrafine bubbles is sprayed to achieve a desired level of decontamination within that body. As another example, it is possible to increase the angular velocity of the electric motor 36 to cause a degree of cavitation that generates a quantity of ultrafine bubbles and increased viscosity of the resultant liquid into a foam.

Activation of the electric motor 36 can optionally occur in response to a signal transmitted by one or a plurality of sensors 13 in or adjacent to the inlet port 12 that detects the presence of the liquid. When liquid is no longer detected by the sensor(s) 13 in the inlet port 12, the electric motor 36 can be deactivated, optionally based the sensor(s) 13 no longer detecting the introduction of the liquid, and optionally without manual intervention to actively deactivate the motor 36. According to other embodiments, the electric motor 36 can optionally be activated in response to a signal caused to be transmitted by a switch. For example, a lever can be pressed when a receptacle is placed in position to receive the liquid with ultrafine bubbles produced by the bubble generator assembly 10. Alternately, a proximity sensor can detect the presence of the receptacle at the fill location. Regardless of how the presence of the receptacle is detected, the electric motor 36 can optionally be automatically activated in response to such placement of the receptacle, and automatically deactivated in response to removal of the receptacle and/or expiration of a defined period of time since activation.

The disc(s) 35 or other rotating structure, nibs 33 and shear wall 32 geometry are modular and interchangeable such that distance D (FIG. 3) may be altered to facilitate processing a variety of liquids. An alternate embodiment includes rotating the mount plate 37 to adjust the spacing D (FIG. 3).

As used herein, “ultrafine bubble” refers to small bubbles that can be roughly 1/2,500 the size of a grain of salt, or less than 200 nanometers (nm) in diameter for example. One wave of ultraviolet C light is longer, at 255 nanometers, by comparison. That means these ultrafine bubbles are extremely small and that small size brings several interesting and unexpected characteristics. By way of example, ultrafine bubbles can be neutrally buoyant and thus remain suspended in liquid (most commonly water) for at least a week or longer, or even a plurality of weeks without rising to the surface and off-gassing upon bursting. It is believed that these ultrafine bubbles have exceptionally-high surface area and retain long residence times in solutions as they retain their electrically charged surfaces. As a result, ultrafine bubbles have many industrial applications such as manufacturing of functional materials, soil and sediment decontamination, pharmaceutical delivery, and disinfection of food products. These extremely small ultrafine bubbles can be an effective method of improving water chemistry and quality.

Although the presence of stable ultrafine bubbles is believed to occur, there is no clear theoretical basis to explain their long-term stability. The stability has been characterized and is usefully understood, but why it is so, is not completely known. Further, any discussion on ultrafine bubbles includes a foray into zeta potential, and in layman's terms, this number, in millivolts, provides a measure and insight into how fast the ultrafine bubbles will aggregate and become larger than 200 nm in diameter, eliminating or at least degrading the benefits of the smaller functional state of ultrafine bubbles.

To activate the electric motor 36, a sensor 13 such as an awetted contact sensor, or the like can be included in electronic control circuitry operatively connected to control operation of the electric motor 36. For example, a sensor 13 in the form of an wetted contact can detect when a user has introduced liquid to the inlet. In response to detecting such liquid, the sensor emits a signal that closes a circuit between a power supply such as a battery or wall mounted power supply and the electric motor 36, thereby energizing the electric motor 36 and causing rotation of the rotor assembly 30 and/or discs 35. When the user introduces liquid to the inlet port 12, liquid flows through the inlet and into the upper liquid cavity 28. Upon entering the upper liquid cavity 28, gravity and the rotation of the disc(s) 35 draws the liquid between the rotor(s) 30 and the shear wall 32, subjecting the liquid to a shearing force, before being collected and exiting the lower liquid cavity 27 through the outlet port 14. Upon exiting the outlet port 14, the liquid with the entrained ultrafine bubbles is retained in a reservoir such as a spray bottle or bucket for later use.

Activation of the electric motor 36 can occur automatically in response to the sensed liquid via sensor 13, and can optionally remain active for a defined period of time, such as eight (8) seconds, for example. Embodiments include a manually operated switch for activating the electric motor 36. Alternative embodiments provide connection from the outlet port 14 directly to a dispensing system for application of the processed liquid directly. As a result, generation of the ultrafine bubbles can occur on demand, at a time when the liquid with the ultrafine bubbles is to be dispensed.

The embodiments of the inlet port 12, bubble generator 16 and outlet port 14 shown in FIG. 1 include the bubble generator 16 as set for in-line processing. However, alternate embodiments can include a bubble generator 16 optionally located as a stand-alone batch processing unit for small volumes such as 1.5 to 3.5 gallons per minute, or significantly scaled up in size to facilitate high volume production processes like 1,000 gallons per minute . . .

The examples described above encapsulate at least one of air, a portion of the molecule(s) constituting the liquid in the reservoir, and a combination thereof in the ultrafine bubbles. However, the present disclosure is not so limited. According to alternate embodiments, other gases such as ozone, carbon dioxide, hydrogen, etc. may be entrained in the ultrafine bubbles based upon the liquid introduced to the device. The ultrafine bubbles of such other gases can be applied across a wide swath of industry. Further, pH, temperature, combination chemistries, etc., can each optionally have an impact on the resulting ultrafine bubble formation. For example, it is believed that, as a general observation, higher pH makes more stable ultrafine bubbles.

After generation, ultrafine bubbles may exist in solution for several weeks and into months. The electrically charged liquid-gas interface of ultrafine bubbles creates inherently repulsive forces on the surfaces of those bubbles. These “like charges” are believed to prevent the bubbles from coalescence and allow high bubble densities which then correspondingly allows highly dissolved gas concentrations in the suspension liquid (such as water) and creates smaller concentration gradients between the bubbles and the liquid (making them more widely and thoroughly distributed). It is also believed that ultrafine bubbles can be further stabilized by, at least in part, each bubble shielding the next against the outflow of gases.

Ultrafine bubbles can be employed in an extensive range of applications such as sanitizing drinking water and wastewater treatment, decontamination of groundwater, decontamination of sediments and soils, biomedical engineering, and industrial applications such as agriculture, fishery (aquaculture), and food.

For water, directly, the treatment of wastewater and drinking water stems from the ultrafine bubble's ability to generate highly reactive free radicals. Ultrafine bubbles can effectively eliminate challenging wastewater treatment issues via bubble oxidation, efficient gas transfer, surfactant removal, and the delivery of oxygen to the biological floc or film, at least in part, killing and removing it. It seems a robust biofilm removal practice with prolonged use.

As an agricultural application of ultrafine bubbles, ultrafine bubbles can create reactive oxygen species that contribute to seed germination. Ultrafine bubbles can also be used to regulate pH levels in liquids utilizing carbon dioxide (CO2). This can be achieved by adding ultrafine CO₂ bubbles, suspended in the water for a prolonged period regulating the combination's pH. Ultrafine bubbles can decrease the size of nutrient clusters and raise ionic mobility aiding in increased nutrient availability and uptake efficiency. For example, plants grown with ultrafine bubble irrigation water are believed to have a higher resilience against stress factors, improving crop quality and reducing crop loss for farmers. With higher oxygen levels, conditions in the water are less favorable to the creation of algae and other harmful compounds that with water that has a lower oxygen level. To irrigate crops, ultrafine bubbles can allow more oxygen to penetrate into the crop roots.

Ultrafine bubbles can also used in fish farming to maintain oxygen levels in water and leading to higher fish survival rates. Ultrafine bubbles are believed to increase dissolved oxygen levels through hyper-efficient gas injection that enables them to neutralize contaminants like algae, algae toxins, pathogens, and other organic materials while increasing oxygen.

In addition to the afore mentioned characteristics, generating liquid with ultrafine bubbles entrained within it is thought to facilitate capillary action of the liquid so inbued increasing soils penetration capability, provide increased efficacy against further biofilm development, and increase antimicrobial efficacy.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of generating ultrafine bubbles in a liquid, the method comprising:
introducing, at atmospheric pressure, a chemistry in dilution;
activating a bubble generator that imparts a shearing force on the liquid within the liquid chamber to cause cavitation of the liquid that results in formation of the ultrafine bubbles; and
retaining the liquid containing the ultrafine bubbles that exits the liquid chamber for use at a later time.

2. The method of claim 1, wherein the liquid into the liquid chamber comprises using the force of gravity to draw the liquid from a reservoir and introduces the liquid to an inlet port of the liquid chamber.

3. The method of claim 2, wherein activating the bubble generator occurs in response to sensing the presence of liquid at the inlet.
